(19) United States
(12) Patent Application Publication
(10) Pub. No.: US 2001/0046230 A1
(43) Pub. Date: Nov. 29, 2001

(54) Method and programmable device for telecommunications applications

(76) Inventor: Michael J. Rojas, North Canton, OH (US)

Correspondence Address: Paul J. Esatto, Jr., Scully, Scott, Murphy & Presser, 400 Garden City Plaza, Garden City, NY, 11530, US

(21) Appl. No.: 09/808,436

(22) Filed: Mar. 14, 2001

Related U.S. Application Data
(60) Provisional application No. 60/189,304, filed on Mar. 14, 2000.

(51) Int. Cl. H04L 12/28

(52) U.S. Cl. 370/389; 370/252

(57) ABSTRACT

A compact computing device with integrated network controller, integrated serial interface, on-board flash memory for non-volatile storage, integrated random access memory for temporary calculations and software execution, integrated single-chip processor, and method for controlling aforementioned components, loading, updating, and executing software that performs a plurality of telecommunication applications, such as the collection, buffering, encryption, and transmission of call record data collected from a private branch exchange telephone switch over a secure, encrypted communication medium, and the management, control, and monitoring over a secure, encrypted communication medium of telecommunication devices such as a private branch exchange telephone switch, a voice mail system, and other associated telecommunication systems. The device provides the ability to remotely configure, control, monitor, and update said telecommunication systems from anywhere in the world via the Internet. The programmable device can also provide the mechanism to perform Web based Application hosting. Specifically, a telecommunications management program can be provided to customers as a hosted service which relieves the need to perform costly installation and performance tuning that for large systems can exceed by several times the actual cost of the purchased software. Users can access the telecommunications program through standard web browsers and perform all normal functionality such as running reports, directory services, billing, etc

### CROSS REFERENCE TO RELATED APPLICATION

This application claim priority from U.S. Provisional Application No. 60/189,304 filed Mar. 14, 2000.

### BACKGROUND OF THE INVENTION

1. Field of the Invention

This invention relates to a method and apparatus for cost accounting of data usage over a network and for a system for web hosting applications for managing telecommunications devices.

2. Prior Art

Internet Data Accounting is currently in its infancy. Currently the data billing paradigm consists of billing per connection, billing based on flat rates, and billing based on packets transferred. Existing systems can only track data packets back to a specific port, and most routers provide little, if any, information. Including additional monitoring software on existing routers badly degrades their performance, which would require organizations to upgrade to considerably larger backbone router hardware at significant cost.

The inherent problem with this approach is that flat rate charges don't apportion costs fairly to users. End users question why they have to pay for access that they didn't use. For example a University might have anywhere from 5-30 routers supporting their LAN and providing Internet access to the students/administration. It may be that 90% of their Internet data traffic is being used by less than 10% of the users, therefore it becomes a requirement to be able to monitor the flow of data traffic by sampling, and provide a fair division/distribution of the costs to the users.

U.S. Pat. No. 5,430,709, assigned to Hewlett-Packard Co., is directed to a network monitoring method and apparatus which involves identifying the protocol data units and the connection to which each unit relates. The system maintains an active group of call records representing each connection that is active. A new call record is created if a protocol data unit is identified as not being in the group. When further data units are identified as being related to a group in the active list, that call record is updated. If for a particular period of time there is no new data unit for a particular call record, the call record is removed from the active list. When call records are removed, they are retained as completed call records. The call record includes quantitative information, such as a number of data bytes transferred for the data units relative to each direction of data flow between the entities involved in the connection. The connection information for each data unit includes the network addresses.

However, there are flaws with this technique. The machine pair key simply implies a from here to there condition. This information is meaningless to the end-user when removed from the context of consumer boundaries. In addition, the machine in use is not as important as who is using the machine. To make matters worse, the machine-to-user relationship is transient and changes often.

U.S. Pat. No. 5,101,402 is directed to a system for monitoring a network which monitors session level packets, determines a session identifier, accumulates information on the packets by the session identifier and calculates session specific data. A session is defined as an extended series of information exchanges between two or more application software programs.

U.S. Pat. No. 5,964,839 is directed to monitoring and data collection of all data being transmitted between two locations using a stub program module for supporting the capture of data. A stub software module is inserted between each API interface in each users application.

Web hosted applications are becoming very popular because they alleviate the need for high end computer performance at the user's site, and eliminate the need for the purchase distribution and installations of software upgrades. As an example, applications used for preparing taxes can be accessed over the web for a much smaller yearly charge than buying new tax tables.

In addition, U.S. Pat. Nos. 5,958,016; 5,940,834 and 5,917,817 disclose systems for providing user access to telephone system information over the Internet. However, at present there is no system for performing web based application hosting of a telecommunications management software suite.

### SUMMARY OF THE INVENTION

The present invention is directed to a compact programmable computing device with an integrated network controller, integrated serial interface, an on-board flash memory for non-volatile storage, an integrated random access memory for temporary calculations and software execution, and an integrated single-chip processor. The present invention is further directed to a method for using the aforementioned components for loading, updating, and executing software that performs a plurality of telecommunication applications, such as the collection, buffering, encryption, and transmission of call record data collected from a private branch exchange telephone switch over a secure, encrypted communication medium. In addition, the device can be used for the management, control, and monitoring over a secure, encrypted communication medium of telecommunication devices such as a private branch exchange telephone switch, a voice mail system, and other associated telecommunication systems. The device provides the ability to remotely configure, control, monitor, and update said telecommunication systems from anywhere in the world via the Internet. By installing the device in lieu of traditional telecommunication management systems, which typically require a personal computer, or greater computing device, the technical skill level for installation personnel is greatly reduced. In addition, the device can then be remotely updated, controlled, monitored, and configured without further assistance from personnel who normally would need to be physically located near the telecommunication systems that are being managed. The device becomes an integral part of communicating with widely scattered telecommunication systems that all participate in a centralized telecommunication management system.

In accordance with the present invention, there is provided a method for cost accounting of data usage over a network by network users, where the network has a plurality of internal IP addresses and access to a plurality of external IP addresses over the Internet. The method comprises the steps of:

(a) detecting data packets having a source and destination IP address moving over the network;

(b) classifying the detected data packets based on the source and destination address;

(c) assigning the classified data packets to a network user;

(d) costing the classified data packets based on a predetermined costing scheme; and

(e) accumulating and storing the costed data packets based on the assigned user.

To accomplish the above method, the device employs an active machine-to-user conversion. A cross-reference table of machines (addresses) to users is maintained on the device. This allows for formation of a matching key that represents a pair of users, not machines, even if that user has moved from one machine to another. In addition, the device also maintains a table of consumer boundaries. Using this information, the user pair is classified. This allows for arrival of a familiar Incoming Call, Outgoing Call, Internal Station to Internal Station, and External Station to External Station classifications. Once classified, a filtering technique can used for disregarding unwanted information at the collection point. For example, a customer may not want to collect station-to-station calls. The amount of data generated by the device can be reduced significantly without losing the important calls.

The present invention also provides a system for web hosting of applications for managing one or more telecommunications devices connected to a local network. The system comprises a host computer having a telecommunications management program and being connected to the Internet, the host computer sending high level telecommunications commands and management data over the Internet by a secure encrypted communication medium. The programmable device of the present invention is used for managing local telecommunications devices. The local programmable device is connected to a local network by a secure encrypted communication medium. One or more telecommunications devices are connected to the local programmable device through the local network. One or more telecommunications devices are directly connected to the local programmable device. The local programmable device collects data from the one or more telecommunications devices and creates data records based on predetermined criteria. The local programmable device monitors and controls the one or more telecommunications devices based on commands from the host computer.

### BRIEF DESCRIPTION OF THE DRAWINGS

FIG. 1 is a block diagram of the main components of the local programmable device of the present invention.

FIG. 2 is a block diagram of the web-hosting system of the present invention for managing telecommunications devices over the Internet

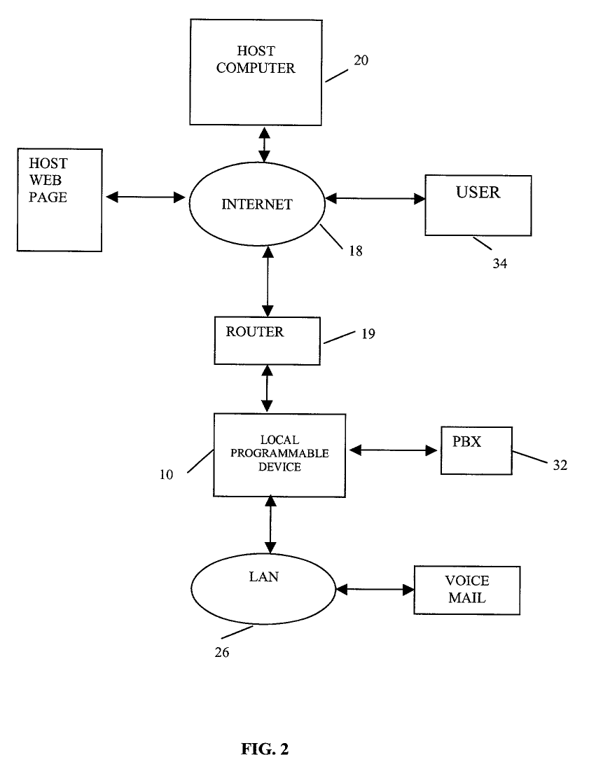

### DETAILED DESCRIPTION OF THE INVENTION

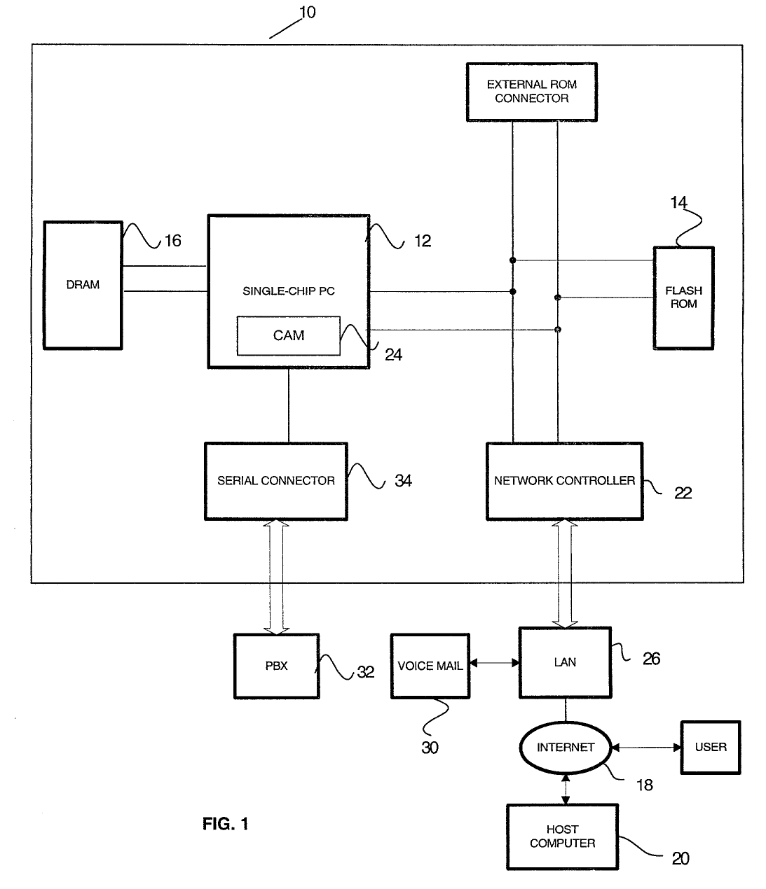

Shown in FIG. 1 is a top-level block diagram of the main components of the hardware device 10 which consists of a single circuit board having a microprocessor 12, a flash memory 14, a DRAM 16, and I/O connections. The device is fully programmable and is intended for a use in a variety of telecommunications applications. The device 10 provides the equivalent functionality to a full-sized PC. Software upgrades can be downloaded into flash memory 14 via the Internet 18 from a host server computer 20.

The low cost hardware device 10 can be programmed for a variety of telecommunication applications. Two will be discussed below; Internet Data Accounting, and Web-based Telecommunications Application Hosting.

### Internet Data Accounting

The device 10 allows a completely new paradigm to be developed based upon a method similar to that currently used for voice (telephone). In the voice environment the billing uses three parameters; the user (source extension), the location called (dialed number), and the usage (duration). In the new billing paradigm the Internet data domain can support three similar parameters; the user (IP address), the destination (IP address), and the usage (data packets/bytes transferred). By providing this information a scheme can be devised to more equitably distribute costs.

The basics of the scheme consist of monitoring the network directly at the access points to the Internet by placing the low cost/programmable device 10 at each of these points. Monitoring consists of decoding each data packet that moves along the data pipe, and generating statistics based upon snapshots at regular intervals. By combining the information from all monitored points a fair representation of the usage/IP address can be achieved.

A classification scheme is used much the same way as the traditional Voice (Telephone) paradigm where one of four call types are determined (Station-to-station, outgoing, incoming, or tandem). Data Accounting classification consists of determining which of four equivalent source-to-destination conditions listed below exist for the point-to-point data packet transfers.

| Source | Destination | Voice Equivalent |
|---|---|---|
| Internal IP address | Internal IP address | Station-to-Station call |
| Internal IP address | External IP address | Outgoing call |
| External IP address | Internal IP address | Incoming call, or |
| External IP address | External IP address | Tandem call |

Such a classification paradigm can be combined with user-definable rules to determine appropriate usage billing schemes similar to current telephony billing. External service charges can be directly applied to internal users of the organization's Internet service. In addition, external charges can be narrowed to specific web sites, or applied very broadly to the whole Internet. Additionally, internal users could be further classified into servers or clients.

One embodiment of the data accounting process of the present invention consists of the following steps:

1. Capture Data Packets

2. Classify Data

3. Filter

4. Assign to User

5. Cache

6. Timeout

7. Archive

The device 10 includes a network controller 22 such as an Ethernet card, and the processor 12 with an integrated Content Addressable (CAM) hardware chip 24.

In the device 10, the classification and filtering steps are implemented using the Content-Addressable Memory 24. The memory 24 is a chip that allows the software developer to accomplish very high-speed search/matches. The CAM 24 reduces the time to evaluate/locate correct ports for Internet data packet transfer based upon the source/destination addresses found in the OSI reference model used to describe Internet protocols.

### Datagram Capture

The first step in the process is the capture of data packets moving over the network. The Ethernet controller 22 detects a packet frame through the preamble or header signals and transfers the data in its internal memory.

### Classification/Costing

This process uses a traditional telephone costing mechanism as the basis for assigning charges to the data packets. The four permutations are based upon the source IP address and destination IP address locations. Namely, are they internal to the user's LAN 26, or external to the user's LAN 26.

The costing can then be classified/assigned as follows:

TABLE

| Source/Destination | Call Type | Costing |
|---|---|---|
| Internal to Internal | Station to Station call | Costed at user-selected rate |
| | | #1 |
| Internal to External | Outgoing Call | Costed at user-selected rate |
| | | #2 |
| External to Internal | Incoming Call | Costed at user-selected rate |
| | | #3 |
| External to External | Tandem Call | Costed at user-selected rate |
| | | #4 |

Classification is performed by matching the source and destination addresses against the IP addresses stored in the CAM 24 and identifying the appropriate call type. Once determined, statistics for the associated PC are initialized/updated and held in storage until a timeout flag causes an archive of the data to a host machine 20.

### Filter

The filter process is used to eliminate or apply special costing to certain types of data packets. This process determines the types of frame packets and flags such frames for non or special costing, such as Unicast, Multicast, or Broadcast messages. Additionally, the user may wish to eliminate from costing those IP addresses that map to e-mail server PCs. Again, this step is performed using the CAM memory 24 as individual bits can be assigned to clients, servers, and specific types of servers.

### Assign to User

The login-logoff information is captured in the host server 20 itself. A variety of techniques are used to, as accurately as possible, determine which users are logged on. This information is then sent to all monitoring devices 10, as often as it changes.

The following techniques are used:

DHCP packets are captured by device 10 to detect when new IP addresses are transiently assigned to machines connecting and disconnecting from the network.

In addition, on a Windows NT network, all login and logoff requests are processed by a central Windows NT server designated as the Primary Domain Controller. This server can provide information to the host 20 that indicates the active users in the network and on which machines they reside.

Using this information, a table of “network logons-to-IP addresses” can be constructed. This table is then sent to the monitoring devices 10.

### Cache/Timeout/Archive

In this embodiment, the process stores a record of a connection identified with a local network user in a cache, setting a flag for a packet relating to a connection not previously cached and resetting a flag for a packet relating to a connection previously cached. Thereafter, the process detects the end of a transmission of a group of related data packets by examining for a lack of a “matching” data packet after a pre-determined length of a time. The record is then archived for use by the billing module at the host computer 20.

A second and preferred embodiment of the data accounting process for the present invention consists of the following steps:

1. Capture Data Packets

2. Classify Data

3. Filter

4. Assign to User

5. Cost/Accumulate/Store

6. Host (AIMWorX) Interrupt

7. Data transfer

8. Reset

In this approach, the processing incorporates a costing/accumulate process after the filter step. At an appropriate timestamp the host server 20 retrieves the accumulated cost information from each device 10 at the client sites and provides the information to the billing module. Note that in this approach the host machine initiates the request to provide the cost data.

### Web Hosted Telecommunications Applications Server

The programmable device can also provide the mechanism to perform Web based Application hosting. Specifically, a telecommunications management program can be provided to customers as a hosted service which relieves the need to perform costly installation and performance tuning that for large systems can exceed by several times the actual cost of the purchased software. Users can access the telecommunications program through standard web browsers and perform all normal functionality such as running reports, directory services, billing, etc.

The system of the present invention for web hosting applications for managing one or more telecommunications devices connected to a local network comprises a host computer 20 having a telecommunications management program and being connected to the Internet 18. The host computer sends high level telecommunications commands and management data over the Internet 18 by a secure encrypted communication medium through a router 19, to a local programmable device 10 for managing local telecommunications devices. The local programmable device 10 is connected to a local network 26 by a secure encrypted communication medium. One or more telecommunications devices, such as voicemail system 30, are connected to the local programmable device through the local network. One or more telecommunications devices such as PBX 32 are directly connected to the local programmable device 10 by serial connector 34. The local programmable device 10 collects data from the one or more telecommunications devices 30, 32 and creates data records based on predetermined criteria. The local programmable device 10 monitors and controls the one or more telecommunications devices based on commands from the host computer 20.

An example of a telecommunications management program is disclosed in U.S. patent application Ser. No. 09/183,414 filed on Oct. 30, 1998, the entirety of which is hereby incorporated by reference.

A user 34 can access a host web page over the Internet to request telemanagement functions provided by the telecommunications management program. The user requests are translated into commands that are transmitted to the local programmable device 10. A program stored in the ROM 14 or DRAM 16 executes the commands and obtains the data from the voicemail or PBX devices in order to retrieve the requested information. Management and control functions are also performed in a similar manner.

The programmable device 10 provides the necessary means to take the place of a variety of devices currently required for supporting a telemanagement system installation. Each of the following devices can be emulated by programming the hardware device with different functionality, and providing a low cost, secure mode of operation.

### Secure LAN Modem

In this mode the device 10 can become a secure LAN modem. This means that it can be used to provide secure access to a Maintenance and Administration Terminal (MAT) at the PBX commonly used to provide low-level administration of telecommunication switches. Also acting as a secure LAN modem the device 10 also provide secure voice mail administration over IP for the voice mail system 30.

### Real-time/Secure SMDR Internet Data Transfer

In this mode the device can eliminate the need to purchase data recorder/buffering devices such as the Pollcat III, which is often used in telecommunication suites between the switch and the data collection application running on the host machine. The software will convert SMDR from any of the supported telecommunication's switches and encrypt the data prior to transmission using Secure Sockets Layer.

While there has been shown and described what is considered to be preferred embodiments of the invention, it will, of course, be understood that various modifications and changes in form or detail could readily be made without departing from the spirit of the invention. It is, therefore, intended that the invention be not limited to the exact forms described and illustrated, but should be constructed to cover all modifications that may fall within the scope of the appended claims.

What is claimed is:

1. A method for cost accounting of data usage over a network by network users, the network having a plurality of internal IP addresses and access to a plurality of external IP addresses over the Internet, the method comprising the steps of:
(a) detecting data packets having a source and destination IP address moving over the network;
(b) classifying the detected data packets based on the source and destination address;
(c) assigning the classified data packets to a network user;
(d) costing the classified data packets based on a predetermined costing scheme; and
(e) accumulating and storing the costed data packets based on the assigned user.

2. The method of claim 1, wherein step b) of classifying the detected data packets includes in one of at least the following four categories:
internal IP address to internal IP address;
internal IP address to external IP address;
external IP address to internal IP address; and
external IP address to external IP address.

3. The method of claim 1, wherein step c) of assigning the classified data packets to the network user includes identifying an IP address to a network user based on network log-on data.

4. The method of claim 1, wherein the predetermined costing scheme of step d) includes a costing factor based on the amount of bandwidth utilization at the time the data packet is detected.

5. The method of claim 1, wherein the costing step d) includes a filtering process to exclude certain predetermined data packets from the costing step.

6. The method of claim 1, further including the step of transferring the accumulated and stored costed data packets to a host computer over the Internet.

7. A programmable device for cost accounting of data usage over a network by network users, the network having a plurality of internal IP addresses and access to a plurality of external IP addresses over the Internet, the device comprising:
a network controller for interfacing with the network and detecting data packets having a source and destination IP address moving over the network;
a processor having a content-addressable memory, the processor classifying the detected data packets based on the source and destination address and assigning the classified data packets to a network user by matching the source and destination addresses against a cross-reference table of IP addresses to network users stored in the content-addressable memory, the processor costing the classified data packets based on a predetermined costing scheme; and
a dynamic random access memory for accumulating and storing the costed data packets based on the assigned user.

8. A system for web hosting applications for managing one or more telecommunications devices connected to a local network comprising:
a host computer having a telecommunications management program and being connected to the Internet, the host computer sending high level telecommunications commands and management data over the Internet by a secure encrypted communication medium; and
a local programmable device for managing local telecommunications devices, the local programmable device being connected to a local network by a secure encrypted communication medium, one or more telecommunications devices being connected to the local programmable device through the local network, one or more telecommunications devices being directly connected to the local programmable device, the local programmable device collecting data from the one or more telecommunications devices and creating data records based on predetermined criteria, the local programmable device monitoring and controlling the one or more telecommunications devices based on commands from the host computer.
